(19) United States
(12) Patent Application Publication
(10) Pub. No.: US 2014/0280736 A1
(43) Pub. Date: Sep. 18, 2014

(54) METHOD FOR PROVIDING VIRTUAL HOME NETWORK AND DEVICE AND SYSTEM THEREFOR, AND COMPUTER READABLE RECORDING MEDIUM

(71) Applicants: Electronics and Telecommunications Research Institute, Daejeon (KR); Hankuk University of Foreign Studies Research and Imdustry-University Cooperation FOundation, Yongie-si, Gyeonggi-do (KR)

(72) Inventors: Dae-Geun Park, Daejeon (KR); Il-Young Chong, Seongnam-si Gyeonggi-do (KR); Yang-Jung Kim, Seoul (KR)

(73) Assignees: Electronics and Telecommunications Research Institute, Daejeon (KR); Hankuk University OF Foreigh Studies Research and Foundation, Yongin-si, Gyeonggi-do (KR)

(21) Appl. No.: 14/354,015

(22) PCT Filed: Nov. 9, 2012
(86) PCT No.: PCT/KR2012/009457

§ 371 Date: Apr. 24, 2014

(30) Foreign Application Priority Data
Nov. 11, 2011 (KR) 10-2011-0117551
Dec. 1, 2011 (KR) 10-2011-0127902

(51) Int. Cl. H04L 12/24

(52) U.S. Cl. CPC H04L 41/50
USPC 709/217

(57) ABSTRACT

Disclosed are a method for providing a virtual home network and a device and a system therefor, and a computer readable recording medium. The present invention provides a home network device comprising: a user unit which receives a service request signal by a user's command or operation, and delivers the service request signal; a checking unit which checks user information and community service group information on the basis of said user request signal; and a processing unit which converts contents included in said service request signal according to a corresponding device and delivers the converted contents, if said user information and said community service group information have been checked.

### CROSS-REFERENCE TO RELATED APPLICATION(S)

This application claims the benefit under 35 U.S.C. §119(a) of Korean Patent Application Nos. 10-2011-0117551, filed on Nov. 11, 2011, and 10-2011-0127902, filed on Dec. 1, 2011, in the Korean Intellectual Property Office, the entire disclosures of which are incorporated herein by references for all purposes.

### BACKGROUND

1. Field

The present invention is related to an apparatus, a system and a method for providing a Virtual Home Network (VHN), and a computer readable recording medium thereof. Specifically, the present invention is related to an apparatus, a system and a method for providing a VHN to configure a personalized service (such as resources and content) provided by individuals so that it is possible to relieve the dependency on a service provider and their services, and a computer-readable recording medium thereof.

2. Description of the Related Art

What is described in this section is only to provide background information of exemplary embodiments of the present invention, not to configure the conventional invention.

The conventional invention is only used to provide a specific service or a limited amount of services provided by a service provider so that it has a limitation in satisfying a user's demand. In this kind of service structure, a user acts as a consumer but fails to play a role as a producer, and thus, a new service environment which considers personal characteristics may not be created.

Hence, an optimized technology which considers personal service characteristics is required. In other words, a technology for enabling a user to easily use a personalized service in a home network in which the user can create, provide and use the service is demanded.

In order to solve the above problems, the present invention is designed to provide an apparatus, a system and a method for providing a VHN to configure a personalized service, and a computer-readable recording medium thereof.

### SUMMARY

According to an exemplary embodiment of the present invention, there is provided a home network apparatus including a user unit configured to receive a service request signal according to a user's command or manipulation, a check unit configured to check user information and community service group information in response to the service request signal, and a processing unit configured to convert content included in the service request signal when the user information and the community service group information have been checked.

According to an exemplary embodiment of the present invention, there is provided a home network apparatus including a virtual home service user management unit configured to receive and transmit a service request signal according to a user's demand or manipulation, a home service registration and management unit configured to store user information of a registered user, a service community management unit configured to store community service group information of a registered community service group, a virtual home community user group management unit configured to check the user information and the community service group information in response to the service request signal, a content location and processing control support unit, configured to, when the user information and the community service group information have been checked, convert content included in the service request signal into a format appropriate to a corresponding home appliance and transmit the converted content to the corresponding home appliance, an application level security support unit configured to perform a decoding or encoding process on the content using a security algorithm, and an application topology management unit configured to support a topology between home appliances connected to one another.

According to an exemplary embodiment of the present invention, there is provided a Virtual Home Network (VHN) system including one or more first community service groups, each constituting a home network between home appliances connected to one another using a home network apparatus, and one or more second community service groups, each constituting a VHN between the first community service groups via a communication network, and the first community service group and the second community service group share content.

According to an exemplary embodiment of the present invention, there is provided a method for providing a Virtual Home Network (VHN), and the method for providing a VHN includes receiving a service request signal according to a user's command or manipulation and transmitting the service request signal, checking user information and community service group information in response to the service request signal, and, when the user information and the community service group information have been checked, converting content included in the service request signal into a format appropriate to a corresponding home appliance and transmitting the converted content to the corresponding home appliance.

Other features and aspects may be apparent from the following detailed description, the drawings, and the claims.

### BRIEF DESCRIPTION OF THE DRAWINGS

FIG. 1 is a block diagram illustrating a virtual home network system according to an exemplary embodiment of the present invention;

FIG. 2 is a block diagram illustrating an example of a home network apparatus according to an exemplary embodiment of the present invention;

FIG. 3 is a flow chart illustrating a method for providing a virtual home network according to an exemplary embodiment of the present invention;

FIG. 4 is an example of a community service group in a virtual home network system according to an exemplary embodiment of the present invention;

FIG. 5 is a diagram illustrating a configuration of a virtual home network service according to an exemplary embodiment of the present invention; and

FIG. 6 is a block diagram illustrating another example of a home network apparatus according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A home-based Service Overlay Network (SON) system is provided in exemplary embodiments of the present invention, and the home-based SON system enables a home-based user to generate, manage and provide a new service, instead of depending on services provided from a service provider. Prior arts may be partly referred with respect to explanation and structure of the home-based SON. Hereinafter, there are provided a system and an apparatus for generating a community to provide a personalized service as well as using a user-created service via a home-tailored SON system in response to a request for the personalized service from a user of a home-based terminal.

Meanwhile, a Virtual Home Network (VHN) according to an exemplary embodiment of the present invention includes a plurality of hybrid home environments. The VHN may be used for other purposes according to necessity of a user who uses the VHN. In addition, a plurality of entities of a home network constitutes a combined home community. The combined community between a plurality of entities generate a physical and logical group environment or a service/user group.

FIG. 1 is a block diagram illustrating a configuration of a VHN system according to an exemplary embodiment of the present invention.

The VHN system according to an exemplary embodiment of the present invention includes a home network apparatus 110, a home network apparatus′ 112, a communication network 120, a first community service group 130, a first community service group′ 132, and a second community service group 140. Although FIG. 1 illustrates the VHN system to include the home network apparatus 100, the home network apparatus′ 112, the communication network 120, the first community service group 130, the first community service group′ 132, and the second community service group 140, it is merely exemplary and those of ordinary skill in the art to which the present invention pertains can change or modify elements of the VHN system as long as the technical distinctiveness and features of the present invention are maintained. FIG. 1 is a diagram illustrating an overall configuration of a VHN system to register and manage a personalized service according to an exemplary embodiment of the present invention.

The home network apparatus 110 and the home network apparatus′ 112 are a kind of relay stations to relay data between home appliances which are connected to each other at home (or on premises). In other words, the home network apparatus 110 is a device which communicates with home appliance performing a communication function to form a home network. Preferably, the home network apparatus 110 may support Internet Protocol Television (IPTV) services but it is not limited thereto, and those of ordinary skill in the art to which the present invention pertains may make change or modification for the home network apparatus 110 as long as the technical distinctiveness and feature of the present invention is maintained. Hereinafter, descriptions for the home network apparatus′ 112 will not be provided since the home network apparatus′ 112 performs technically the same operations of the home network apparatus 110.

That is, the home network apparatus 110 refers to an apparatus to establish data communication connection. In other words, the home network apparatus 110 is an apparatus which reads a receiver's address from a transmitter's information, designates the most adequate communication path for data and transmits the data to a different communication network via the most adequate communication path. The home network apparatus 110 may extract a location of a data packet, designate the most adequate communication path for the extracted location, transmit the data packet to a different apparatus via the designated communication path and share a plurality of lines with other apparatuses in a general network environment. In an exemplary embodiment of the present invention, the home network apparatus 110 may be used as an Access Point (AP), an Router, an Repeater, a relay station, a bridge and the like.

That is, as shown in FIG. 1, various kinds of home appliances including a desktop computer, a laptop computer, a pad computer and a smart phone use a service integration entity (for example, an SON) with respect to the home network apparatus 110 so as to connects with a community service internally or externally. Such services may be shared between users of a virtual home community. In the end, a service may be generated by and provided for the users of the virtual home service. In addition, communication in a home network may be protected using a security mechanism of a virtual community.

At this time, the SON refers to a network which is configured on an existing network. That is, the SON is a virtual network which is composed of additional nodes and logical links and configured on the existing network. In an overlay network, adjacent nodes mean logically adjacent nodes, rather than physically adjacent nodes. It is possible to provide a more efficient network service by utilizing the existing network. In other words, the SON means a network in which, out of necessity, a new logical topology is reconfigured on a physically or logically existing topology so that it may achieve improved performance and efficiency and provide various functions.

Of course, the home network apparatus 110 is not necessarily limited to establish an SON, and may establish a wireless or wired home network between home appliances using a shot-distance communication module that has been previously equipped. For example, ports of the home network apparatus 110 and the home appliances may be connected to each other via communication cables, so that a wired network between home appliances may be established. In addition, a predetermined frequency may be set for communication between the home network apparatus 100 and the home appliances, so that a wireless network between home appliances may be established. Herein, the short-distance communication module may support at least one of WLAN, Wi-Fi, Radio Frequency Identification (RFID), Bluetooth, Infrared Data Association (IrDA), Zigbee, Ultra Wideband and Near Field Communication (NFC).

The home network apparatus 110 according to an exemplary embodiment of the present invention is able to be connected to a Tablet PC, a laptop computer, a Personal Computer (PC), a smart phone, a Personal Digital Assistant (PDA) and a mobile communication terminal. In addition, the home network apparatus 110 is able to be connected to an additional external router which is connected to the communication network 120. Meanwhile, the home network apparatus 110 communicates with home appliances connected to each other to establish a home network, and this kind of home network is called a first community service group 130. Herein, examples of the additional external router also include an additional AP, an additional repeater, an additional relay station and an additional bridge. Meanwhile, the home network apparatus 110 of the first community service group 130 communicates with the home network apparatus′ 112 of the first community service′ 132 to establish a VHN, and this kind of VHN is called a second community service group 140.

Primary operations of the home network apparatus 110 according to an exemplary embodiment of the present invention include receiving a service request signal according to a user's command or manipulation, transmitting the service request signal, in response to the service request signal, checking user information and community service group information, in response to the user information and the community service group information being checked, converting content included in the service request signal into a format appropriate to a corresponding home appliance, and transmitting the converted content to the corresponding home appliance. At this time, the home network apparatus 110 may store information on a registered user and information of a registered community service group. In addition, the home network apparatus 110 decodes and encodes the content using a security algorithm and supports a topology between home appliances connected to each other, and the home network apparatus 110 may use an application layer and a transport layer for the decoding or encoding process. Herein, the topology means one of various connection methods (for example, a ring topology, a star topology, a mesh topology and a hybrid topology) in which network elements (for example, a link and a node) are physically connected to each other.

In order to search for content, the home network apparatus 110 according to an exemplary embodiment of the present invention first checks the first community service group 130 and then the second community group 140. The first community service group constitutes a home network between home appliances connected one another, and the second community service group 140 constitutes a VHN between the first service community groups via the communication network 120. In addition, the home network apparatus sorts out the user information about users who use the same service in the community service group, classifies the user information into the same user group and manages the user information on an individual user group basis. Meanwhile, the home network apparatus 100 manages the user information included in the community service group information on the application layer.

The communication network 120 refers to a network which is able to transmit and receive data using a protocol based on wired and wireless various communication techniques, such as an Internet network, an Intranet network, a mobile network and a satellite network. Meanwhile, the communication network 120 may include a cloud computing network which is connected to the home network apparatus 110, stores computing resources, such as hardware and software, and transmits to a corresponding home appliance what a client requests out of the computing resources. Herein, the cloud computing refers to a computer environment in which information is permanently stored in an Internet server, but temporarily in a client terminal such as a desktop, a tablet PC, a laptop, a net book and a smart phone. In this manner, entire information about a user may be stored in an Internet server and able to be used using various kinds of IT home appliances anytime anywhere.

In addition, the communication network 120 includes CDMA (Code Division Multiple Access), WCDMA (Wideband Code Division Multiple Access), GSM (Global System for Mobile Communications), LTE (Long Term Evolution), EPC (Evolved Packet Core) and next generations of a network and a cloud computing network, as well as closed networks, such as LAN (Local Area Network) and WAN (Wide Area Network), and open networks such as the Internet.

Each of the first community service group 130 and the first community service group′ 132 is a community group, and home appliances of the community are connected to one another at home to constitute a home network using the home network apparatus 110. Hereinafter, explanations about the first community service group′ 132 will not be provided since the first community service group′ 132 is technically identical to the first community service group 130. The second community service group 140 is another community group which constitutes a VHN between the first community service groups via the communication network 120. The first community service group 130 and the second community service groups 140 share content with each other.

The first community service group 130 and the second community service group 140 may constitute a home—based Service Overlay Network (SON) system, thereby enabling a new service to be applied at home and a new service community to be generated. Herein, the new service means that the home network apparatus 100 for providing a personalized content at home performs media conversion according to each home appliance of a different home, thus reducing dependency on a service provider. The home-based SON system formed by the first community service group 130 and the second community service group 140 may provide an environment necessary for a user to directly generate, manage and provide a service. That is, it is possible to generate the first community service group 130, an internal community of one home, and to generate the second community service group 140, an external community, in association with the home network apparatus′ 112 of a different home.

As a result, home content may be shared and a personalized service may be provided. Specifically, as the home network apparatus 110 configured to performing a home-based SON function is installed at home, it is possible for a user to create an optimal service environment and provide a personalized service, without depending on a personalized service provider any longer. That is, it is structured such that service and resource policies not provided by a service provider are able to be personalized and then provided to another community group. In other words, with the personalized service provided at home, it is possible to provide the personalized services alone or along with services provided by a service provider, and even the home network apparatus′ 112 of the outside (or a different home) is able to use the service environment of the home network apparatus 110, if being connected to the home network apparatus 110.

In one of examples of applying the first community service group 130 and the second community service group 140, if the first community service group 130, a virtual service community, is established at home, relatives and friends are able to access services of the first community service group. In addition, the first community service group 130 may be connected to the first community service group′ 132 of a different home, which belongs to one of the relatives or friends, and the first community service group 130 and the first community service group′ 132 constitute the second community service group 140. In addition, once a user establishes a home network optimized for his or her preferred services, the user may use the optimized home service anytime anywhere as if the user exists at home. That is, it is possible to use, manage and/or maintain the home environment even when the user is out of home, thereby establishing a personal service enabler at home.

FIG. 2 is a block diagram illustrating a home network apparatus according to an exemplary embodiment of the present invention.

The home network apparatus 110 according to an exemplary embodiment of the present invention includes a user unit 210, a check unit 220, a registration unit 230, a community management unit 240, a processing unit 250, a security support unit 260 and a community topology unit 270.

Although FIG. 2 illustrates the home network apparatus 110 to include the user unit 210, the check unit 220, the registration unit 230, the community management unit 240, the processing unit 250, the security support unit 260 and the community topology unit 270, it is merely exemplary and those of ordinary skill in the art to which the present invention pertains can change or modify elements of the home network apparatus 110 as long as the technical distinctiveness and features of the present invention is maintained.

The user unit 210 is a functional unit which sends a signal in response to any kind of home service, and acts as a gateway in a VHN system when generating the first community service group 130, an internal community, and the second community service group 140, an external community. That is, the user unit 210 receives a service request signal according to a user's command or manipulation and sends the service request signal to the check unit 220.

The check unit 220 primarily checks whether a home service user has registered in an internal home service community or an external home service community. The check unit 220 checks user information and community service group information in response to the user request signal from the user unit 210. In addition, in order to search for content, the check unit 220 first checks the first community service group 130 and then the second community group 140. The first community service group constitutes a home network between home appliances connected to one another, and the second community service group 140 constitutes a VHN between the first service community groups via the communication network 120. Meanwhile, the check unit 220 sorts out the user information about users, who use the same service in the community service groups, classifies the user information into the same user group and manages the user information on an individual user group basis.

The registration unit 230 registers a user-created service and search for the corresponding service. In addition, the registration 230 stores information about a registered user. The community management unit 240 is in charge of management in the process of creating an internal or external service community. The community management unit 240 stores information about a registered community service group. The community management group 240 manages the user information included in the community service group information on the application layer.

The processing unit 250 converts a location of a streaming content when transmitting and/or receiving the streaming content, and also converts the content to have definition adequate to each home appliance. That is, when the user information and the community service group information have been checked, the processing unit 250 converts content included in a service request signal into a format appropriate to a corresponding home appliance and transmits the converted content to the corresponding home appliance.

The security support unit 260 decodes or encodes the content using a security algorithm. At this time, the security support unit 260 uses an application layer and a transport layer for the decoding or encoding process. The community topology unit 170 supports a topology between home appliances connected to one another.

FIG. 3 is a flow chart illustrating a method for providing a VHN according to an exemplary embodiment of the present invention.

The user unit 210 of the home network apparatus 110 receives a service request signal according to a user's command or manipulation in S310 and transmits the service request signal to the check unit 220 in S320. In S320, the user unit transmits the service request signal to the check unit 220 in order to manage and authenticate a home user.

In response to the service request signal, the check unit 220 of the home network apparatus 110 transmits a check request signal to the registration unit 230 in order to check user information in S330. The registration 230 of the home network apparatus 110 transmits to the check unit 220 a check response signal corresponding to the received check request signal in S340. That is, in S340, the registration unit 230 checks whether the user information included in the check request signal is information of a registered user, generates a check response signal including the check result and transmits the generated check response signal to the check unit 220.

If the check response signal is received from the registration unit 230, the check unit 220 of the home network apparatus 110 checks the check response signal and controls the community management unit 240 to check community service group information in S350. That is, in S350, the check unit 220 transmits the check request signal to the community management unit 240 to check the community service group information. The community management unit 240 transmits to the check unit 220 a check response signal corresponding to the check request signal received from the check unit 220. At this time, the community management unit 240 checks whether the community service group information included in the check request signal is information about a registered user, generates a check response signal including the check result and transmits the generated check response signal to the check unit 220.

That is, the registration unit 230 of the home network apparatus 110 stores information about a registered user; the community management unit 240 of the home network apparatus 110 stores information about a registered community service group; and the check unit 220 checks the user information and the community service group information via the registration unit 230 and the community management unit 240. When the user information and the community service group information have been checked in the registration unit 230 and the community management unit 240, respectively, the check unit 220 of the home network apparatus 110 transmits to the processing unit 250 a conversion request signal to convert content included in the service request signal into a format appropriate to a corresponding home appliance in S360.

The processing unit 250 of the home network apparatus 110 converts the content included in the service request signal into a format appropriate to a corresponding home appliance in S370, and then transmits the converted content to the corresponding home appliance requested by the service request signal. The security support unit 260 of the home network apparatus 110 may decodes or encodes the content using a security algorithm in S380. For example, if the processing unit 250 has completely converted the content included in the service request signal into the format appropriate to the corresponding home appliance, the security support unit 260 may decode the converted content and transmit the decoded content to the corresponding home appliance, and the corresponding home appliance may encodes the decoded content.

Meanwhile, in order to check content, the check unit 220 of the home network apparatus 110 may first checks the first community service group 130 and then the second community group 140. The first community service group constitutes a home network between home appliances connected to one another, and the second community service group 140 constitutes a VHN between the first service community groups via the communication network 120. In addition, the home network apparatus 110 may sort out the user information about users, who use the same service in the community service group, classifies the user information into the same user group and manages the user information on an individual user group basis.

Although FIG. 3 illustrates that steps of S310 to S380 are performed sequentially, it is merely exemplary and those skilled in the art to which the present invention pertains may understand that the sequence of the S310 to S380 may be changed or one or more steps of S310 to S380 may be performed in parallel as long as the technical distinctiveness and features of the present invention are maintained. Therefore, FIG. 3 is not limited to be performed in time series.

The above-described method for providing a VHN according to an exemplary embodiment of the present invention, shown in FIG. 3, may be realized as a program and recorded in a computer readable recording medium. The computer recording medium which records a program for realizing the method for providing a VHN according to an exemplary embodiment of the present invention includes all kinds of recording media which store data readable by a computer system. Examples of the computer readable recording media include ROM, RAM, CD-ROM, a magnetic tape, a floppy disk and an optical data storage home appliance and may be realized in a carrier wave form (for example, transition via the Internet). In addition, the computer-readable recording medium is distributed in a computer system connected via a network so that computer-readable codes are stored and executed in a distributed manner. In addition, functional programs, codes and code segments used to embody the present invention may be easily anticipated by programmers in the technical field of the present invention.

FIG. 4 is a diagram illustrating an example of community service groups in a VHN system according to an exemplary embodiment of the present invention.

FIG. 4 shows an example of IPTV virtual home community services in an SON environment. That is, the IPTV virtual home community services form a community group. The community group is a group of users who belongs to the same community in the SON. For example, as shown in FIG. 4, each of ‘User 3’, ‘User 4’, ‘User 5’ and ‘User 7’ is considered to constitute a communication group, an internal home network. That is, ‘User 3’, ‘User 4’, ‘User 5’ and ‘User 7’ may constitute the second communication group. In addition, if each of ‘User 1’, ‘User 2’, ‘User 3’ and ‘User 6’ is considered to constitute a communication group, an internal home network. That is, ‘User 1’, ‘User 2’, ‘User 3’ and ‘User 6’ may constitute the second communication group′.

The IPTV virtual home community services of the VHN may constitute a virtual community, similar to a web community, which allows a home network subscriber to use a plurality of IPTV service applications. At this time, a user may register in the community using an application. Once the community is formed on a service level, a connection to virtual home IPTV services is established based on a VHN connection for which community information is used. At this time, features suitable for the virtual home IPTV, such as security and Quality of Service (QoS), are provided via the SON.

FIG. 5 is an example of a configuration of a VHN service according to an exemplary embodiment of the present invention.

FIG. 5 illustrates a configuration of IPTV virtual home community services on a virtual home-based SON. The IPTV VHN forms IPTV community groups (for example, IPTV virtual home community service 1˜IPTV virtual home community service n) within IPTV service application functions.

FIG. 6 is a block diagram illustrating another example of a home network apparatus according to an exemplary embodiment of the present invention.

In another example, the home network apparatus 110 includes a virtual home service user management unit 610, a home service registration and management unit 620, a content location and processing control support unit 630, a service community management unit 640, a virtual home community user group management unit 650, an application level security support unit 660 and a community topology management unit 670.

Although FIG. 6 illustrates the home network apparatus 110 to include the virtual home service user management unit 610, the home service registration and management unit 620, the content location and processing control support unit 630, the service community management unit 640, the virtual home community user group management unit 650, the application level security support unit 660 and the community topology management unit 670, it is merely exemplary and those skilled in the art to which the present invention pertains may modify or alter the elements of the home network apparatus 110 as long as the technical distinctiveness and features of the present invention are maintained.

The virtual home service user management unit 610 sends a signal in response to any kinds of home services, and acts as a gateway in the VHN system when the first community service group 130, an internal community, and the second community service group 140, an external community, are generated. That is, the virtual home service user management unit 610 receives a service request signal according to a user's command or manipulation and transmits the service request signal to the virtual home community user group management unit 650. The home service registration and management unit 620 registers a user-generated service and searches for the corresponding service. Meanwhile, the home service registration and management unit 620 stores information about a registered user.

The content location and processing control support unit 630 converts a location of a streaming content when transmitting and/or receiving the streaming content, and also converts the streaming content to have a definition adequate to each home appliance. That is, when the user information and the community service group information have been checked, the content location and processing control support unit 630 performs a conversion on content included in the service request signal according to a corresponding home appliance and transmits the converted content to the corresponding home appliance. The service community management unit 640 is in charge of management in the process of creating an internal or external service community. The service community management unit 640 manages the user information included in community service group information on the application layer.

The virtual home community user group management unit 650 primarily checks whether a home service user has registered in an internal or external community. The virtual home community user group management unit 650 checks user information or community service group information based on the user request signal received from the virtual home service user management unit 610. In addition, in order to search for content, the virtual home community user group management unit 650 first checks the first community service group 130 and then the second community group 140. The first community service group constitutes a home network between home appliances connected to one another, and the second community service group 140 constitutes a VHN between the first service community groups via the communication network 120. Meanwhile, the virtual home community user group management unit 650 sorts out the user information about users, who use the same service in the community service groups, classifies the user information into the same user group and manages the user information on an individual user group basis.

The application level security support unit 660 decodes or encodes content using a security algorithm. At this time, the application level security support unit 660 uses an application layer and a transport layer for the decoding or encoding process. The community topology management unit 670 supports a topology between home appliances connected to one another.

As described above, the effect of the present invention is to enable a user to configure a personalized service (such as resources and content) provided by individuals for configuring a home-based SON so that it is possible to relieve the dependency on a service provider and their services.

In addition, the minimized home-based SON environment may be provided to offer a home-based personal service so that a user may escape from the conventional consumption-oriented service pattern that leads to high dependency on a service provider. It also may trigger a widespread of personalized services. Furthermore, even when a user is out of home or at a remote area, the user may receive an optimized service upon accessing the home-based SON system as if the user exists at home, thereby maximizing efficiency.

According to exemplary embodiments of the present invention, it is possible to generate, manage and provide a personalized service via the home-based SON system, and this characteristic may help to personalize and diversify services as well as satisfying a user's demand for a service. As a result, long tail content and services may be achieved with reduced service costs.

A number of examples have been described above. Nevertheless, it should be understood that various modifications may be made. For example, suitable results may be achieved if the described techniques are performed in a different order and/or if elements in a described system, architecture, home appliance, or circuit are combined in a different manner and/or replaced or supplemented by other elements or their equivalents. Accordingly, other implementations are within the scope of the following claims.

What is claimed is:

1. A home network apparatus comprising:
a user unit configured to receive a service request signal according to a user's command or manipulation;
a check unit configured to check user information and community service group information in response to the service request signal; and
a processing unit configured to convert content included in the service request signal when the user information and the community service group information have been checked.

2. The home network apparatus of claim 1, wherein the check unit first checks one or more first community service groups and then one or more second community service group in order to search for the content, wherein each of the first community service groups constitutes a home network between home appliances connected to one another and each of the second community service groups constitutes a Virtual Home Network (VHN) between the first community service groups via a communication network.

3. The home network apparatus of claim 1, further comprising:
a registration unit configured to store the user information of a registered user; and
a community management unit configured to store the community service group information of a registered community service group.

4. The home network apparatus of claim 1, further comprising:
a security support unit configured to perform a decoding or encoding process using a security algorithm; and
a topology unit configured to support a topology between home appliances connected to one another.

5. The home network apparatus of claim 1, wherein the community management unit manages the user information included in the community service group information on an application layer.

6. The home network apparatus of claim 1, wherein the check unit sorts out the user information about users, who use a same service in the community service group, classifies the user information into a same user group and manages the user information on an individual user group basis.

7. A home network apparatus, comprising:
a virtual home service user management unit configured to receive and transmit a service request signal according to a user's demand or manipulation;
a home service registration and management unit configured to store user information of a registered user;
a service community management unit configured to store community service group information of a registered community service group;
a virtual home community user group management unit configured to check the user information and the community service group information in response to the service request signal;
a content location and processing control support unit, configured to, when the user information and the community service group information have been checked, convert content included in the service request signal into a format appropriate to a corresponding home appliance and transmit the converted content to the corresponding home appliance;
an application level security support unit configured to perform a decoding or encoding process on the content using a security algorithm; and
an application topology management unit configured to support a topology between home appliances connected to one another.

8. The home network apparatus of claim 7, wherein the virtual home community user group management unit first checks one or more first community service groups and then one or more second community service groups, wherein each of the first community service groups constitutes a home network between home appliances connected to one another and each of the second community service groups constitutes a Virtual Home Network (VHN) between the first community service groups.

9. The home network apparatus of claim 7, wherein the virtual home community user group management unit sorts out the user information about users, who use a same service in the community service group, classifies the users into a same user group and manages the user information on an individual user group basis.

10. The home network apparatus of claim 7, wherein the application level security support unit uses an application layer and a transport layer for the decoding or encoding process.

11. The home network apparatus of claim 7, wherein the service community management unit manages the user information included in the community service group information on the application layer.

12. A Virtual Home Network (VHN) system, comprising:
one or more first community service groups, each constituting a home network between home appliances connected to one another using a home network apparatus; and
one or more second community service groups, each constituting a VHN between the first community service groups via a communication network,
wherein the first community service groups and the second community service groups share content.

13. A method for providing a Virtual Home Network (VHN), comprising:
receiving a service request signal according to a user's command or manipulation and transmitting the service request signal;
checking user information and community service group information in response to the service request signal; and
when the user information and the community service group information have been checked, converting content included in the service request signal into a format appropriate to a corresponding home appliance and transmitting the converted content to the corresponding home appliance.

14. The method of claim 13, wherein the checking of the user information and the community service group information comprises first checking one or more first community service groups and then checking one or more second community service groups in order to search for the content, wherein each of the first community service groups constitutes a home network between home appliances connected to one another and each of the second community service groups constitutes the VHN between the first community service groups via a communication network.

15. The method of claim 13, further comprising:
storing the user information of a registered user; and
storing the community service group information of a registered community service group.

16. The method of claim 13, further comprising:
performing a decoding or encoding process on the content using a security algorithm; and
supporting a topology between the home appliances connected to one another.

17. The method of claim 16, wherein the performing of the decoding or encoding process on the content comprises using an application layer and a transport layer to perform the decoding or encoding process.

18. The method of claim 13, wherein the storing of the user information comprises managing the user information included in the community service group information on the application layer.

19. The method of claim 13, wherein the checking of the user information and the community service group information comprises sorting out the user information about users, who use the same service in the community service group, classifying the user information into the same user group and managing the user information on an individual user group basis.
